(19) United States
(12) Patent Application Publication
(10) Pub. No.: US 2018/0062876 A1
(43) Pub. Date: Mar. 1, 2018

(54) CONTROL APPARATUS, INFORMATION PROCESSING APPARATUS, METHOD FOR PRESENTING VIRTUAL NETWORK, AND PROGRAM

(71) Applicant: NEC CORPORATION, Tokyo (JP)

(72) Inventors: Yohei IIZAWA, Tokyo (JP); Kazuya SUZUKI, Tokyo (JP)

(73) Assignee: NEC CORPORATION, Tokyo (JP)

(21) Appl. No.: 15/557,672

(22) PCT Filed: Mar. 10, 2016
(86) PCT No.: PCT/JP2016/057524

§ 371 Date: Sep. 12, 2017

(30) Foreign Application Priority Data
Mar. 13, 2015 (JP) 2015-051229

(51) Int. Cl. H04L 12/46; H04L 12/24; G06F 9/455; H04L 12/717

(52) U.S. Cl. CPC H04L 12/4641; H04L 41/0856; H04L 45/38; H04L 45/42; G06F 9/45558

(57) ABSTRACT

A control apparatus comprises a creation unit creates a virtual network on the basis of the state of physical resources and a resource separation unit separates resources allocated to the virtual networks created by the creation unit for each virtual network.

### FIELD

### Reference to Related Application

The present invention is based upon and claims the benefit of the priority of Japanese patent application No. 2015-051229 filed on Mar. 13, 2015, the disclosure of which is incorporated herein in its entirety by reference thereto.

The present invention relates to a control apparatus, information processing apparatus, method for presenting virtual network, and program, and particularly to a control apparatus, information processing apparatus, method for presenting virtual network, and program that logically divide a network and provide it as a virtual network.

### BACKGROUND

Patent Literature 1 discloses an information system capable of controlling a path configured for each network logically divided. According to the literature, a control server in the information system is connected to a plurality of physical nodes that hold control information defining an operation corresponding to the characteristics of an input/output packet and that perform processing on an input/output packet according to the control information. Further, the control server comprises a first storage unit that stores configuration information of a virtual network including a virtual node virtualizing the physical nodes and a second storage unit that stores virtual network identifying information identifying the virtual network from the characteristics of an input packet, identifies a physical node configuring a virtual network that handles a packet having a characteristic in common with a packet received by the physical node on the basis of a request from the physical node, and updates the control information for each of the physical nodes.

Patent Literature 2 discloses a method for managing networking resources in a site comprising a plurality of hosts and physical forwarding elements. According to the literature, the method identifies a first set of virtual machines using a first set of the plurality of hosts and physical forwarding elements; identifies a second set of virtual machines using a second set of the plurality of hosts and physical forwarding elements; and provides first and second distributed virtual switches that exclusively handle communications between the first and second sets of virtual machines, respectively, while maintaining isolation between the first and second sets of virtual machines and making sure that some of the hosts and physical forwarding elements in the first and second sets are the same.

### [Patent Literature 1]

### International Publication Number WO2011/043416

### [Patent Literature 2]

Japanese Patent Kohyo Publication No. JP-P2012-525017A

### SUMMARY

The following analysis is given by the present invention. By using the technologies described in Patent Literatures 1 and 2, a plurality of users (also known as “tenants,” particularly referring to corporate users) can share physical resources. In the methods in Patent Literatures 1 and 2, however, services for each user are divided in logical areas and resources are not physically divided.

As a result, when a user is provided a dedicated network, he may actually be sharing physical resources with another user. Further, in a case such as Patent Literature 1 using an OpenFlow switch, resources can be effectively utilized by aggregating flows, but on the other hand, actual physical resources assigned to a user cannot be seen or are hard to see. In this regard, Patent Literature 2 has the same issue; two communications are exclusively handled in a virtualization layer and physical resources (the physical forwarding elements) are shared by a plurality of users (refer to Claim 7, etc.).

It is an object of the present invention to provide a control apparatus, information processing apparatus, method for presenting virtual network, and program capable of contributing to increasing the number of methods for providing a virtual network to a plurality of clients in a single network.

According to a first aspect of the present invention, there is provided a control apparatus comprising a creation unit configured to create a plurality of virtual networks on the basis of the state of physical resources. The control apparatus further comprises a resource separation unit configured to separate resources allocated to the virtual networks created by the creation unit for each virtual network.

According to a second aspect, there is provided an information processing apparatus comprising an acquisition unit configured to acquire information of a plurality of virtual networks from a first apparatus that comprises a creation unit configured to create the plurality of virtual networks on the basis of the state of physical resources; and a resource separation unit configured to separate resources allocated to the plurality of virtual networks for each virtual network.

According to a third aspect, there is provided a method for presenting virtual network including: acquiring information of a plurality of virtual networks from a first apparatus that comprises creation means for creating the plurality of virtual networks on the basis of the state of physical resources; and separating resources allocated to the created virtual networks for each virtual network. The present method is tied to a particular machine such as a computer that presents the information of virtual networks to a user.

According to a fourth aspect, there is provided a program having a computer execute a process of acquiring information of a plurality of virtual networks from a first apparatus that comprises creation unit for creating the plurality of virtual networks on the basis of the state of physical resources; and a process of separating resources allocated to the created virtual networks for each virtual network. Further, this program can be stored in a computer-readable (non-transient) storage medium. In other words, the present invention can be realized as a computer program product.

The meritorious effects of the present invention are summarized as follows.

According to the present invention, it becomes possible to meet the demands of users of virtual networks. Further, the present invention converts the control apparatuses described in Background into a control apparatus that creates a virtual network in a form in which physical resources actually allocated can be easily grasped.

### BRIEF DESCRIPTION OF THE DRAWINGS

FIG. 1 is a drawing showing the configuration of a first example embodiment of the present disclosure.

FIG. 2 is a drawing showing the configuration of a second example embodiment of the present disclosure.

FIG. 3 is a drawing showing the configuration of a third example embodiment of the present disclosure.

FIG. 4 is a flowchart showing the operation of a control apparatus of the third example embodiment of the present disclosure.

FIG. 5 is a drawing showing the configuration of a fourth example embodiment of the present disclosure.

FIG. 6 is a drawing showing an example of node information stored in a first network information storage unit of a control apparatus of the fourth example embodiment of the present disclosure.

FIG. 7 is a drawing showing an example of port information stored in the first network information storage unit of the control apparatus of the fourth example embodiment of the present disclosure.

FIG. 8 is a drawing showing an example of link information stored in the first network information storage unit of the control apparatus of the fourth example embodiment of the present disclosure.

FIG. 9 is a drawing showing the topology of a first network of the fourth example embodiment of the present disclosure.

FIG. 10 is a drawing showing an example of node information stored in a second network information storage unit of the control apparatus of the fourth example embodiment of the present disclosure.

FIG. 11 is a drawing showing an example of port information stored in the second network information storage unit of the control apparatus of the fourth example embodiment of the present disclosure.

FIG. 12 is a drawing showing an example of link information stored in the second network information storage unit of the control apparatus of the fourth example embodiment of the present disclosure.

FIG. 13 is a drawing showing the topology of a second network of the fourth example embodiment of the present disclosure.

FIG. 14 is a drawing showing an example of layer boundary information set in a hierarchy control unit of the control apparatus of the fourth example embodiment of the present disclosure.

FIG. 15 is a drawing showing an example of service information held by a resource separation unit of the control apparatus of the fourth example embodiment of the present disclosure.

FIG. 16 is a drawing showing an example of service allocation information held by the resource separation unit of the control apparatus of the fourth example embodiment of the present disclosure.

FIG. 17 is a drawing showing an example of a network configuration for explaining the operation of the fourth example embodiment of the present disclosure.

FIG. 18 is a flowchart showing the operation (preparation process) of the control apparatus of the fourth example embodiment of the present disclosure.

FIG. 19 is a drawing showing a state in which links are created for a user A over a virtual network in the fourth example embodiment of the present disclosure.

FIG. 20 is a drawing showing an example of flow information corresponding to the links between LN1 and LN2 in FIG. 19.

FIG. 21 is a drawing showing arrow lines representing the flow information of FIG. 20 over FIG. 9.

FIG. 22 is a drawing showing a virtual network for a user A presented to the user A in the fourth example embodiment of the present disclosure.

FIG. 23 is a drawing showing a virtual network for a user B presented to the user B in the fourth example embodiment of the present disclosure.

FIG. 24 is a flowchart showing the operation (flow addition process) of the control apparatus of the fourth example embodiment of the present disclosure.

FIG. 25 is a drawing showing an example of a flow set by the user A for a virtual network in the fourth example embodiment of the present disclosure.

FIG. 26 is a drawing showing an example of flow information set in the second network information storage unit by the control apparatus of the fourth example embodiment of the present disclosure.

FIG. 27 is a drawing showing an example of control information set in the second network by the control apparatus of the fourth example embodiment of the present disclosure.

FIG. 28 is a drawing showing user flows over a virtual network constituted by the control apparatus of the fourth example embodiment of the present disclosure.

### MODES

### Example Embodiment 1

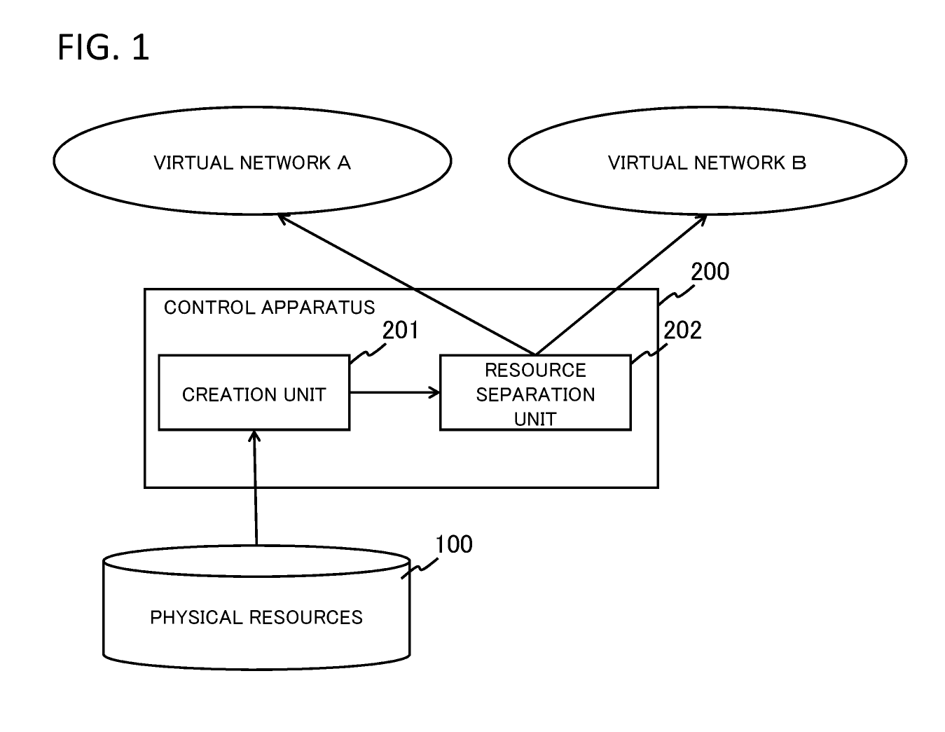

Next, a first example embodiment of the present disclosure will be described in detail with reference to the drawings. FIG. 1 is a drawing showing the configuration of the first example embodiment of the present disclosure. FIG. 1 shows a control apparatus 200 that comprises creation unit 201 and resource separation unit 202 and that is able to access physical resources 100.

The creation unit 201 creates a plurality of virtual networks (virtual networks A and B in FIG. 1) on the basis of the state of the physical resources 100. Further, as stated below, since the resource separation unit 202 displays physical resources allocated to a virtual network, it is preferable that the creation unit 201 give an identifier, etc., to resources allocated to a user when a virtual network is created.

The resource separation unit 202 separates the resources allocated to the virtual networks created by the creation unit 201 (the virtual networks A and B in FIG. 1) for each virtual network. For instance, the resource separation unit 202 separates the resources for the virtual network A in FIG. 1 so as to be able to identify the resources allocated to the virtual network (logical resources constituted by using physical links, physical nodes, and physical resources allocated to the virtual network) and display the resources as necessary. The resource separation unit 202 may display this information on a user terminal in the virtual network without being limited thereto. The information may be displayed on a display device connected to the control apparatus 200 or on a management server of a service provider who provides services to users in the virtual network. Alternatively, the information may be displayed on software that controls each virtual network.

As described above, according to the present example embodiment, a user of a virtual network is able to recognize the resources allocated to the virtual network.

### Example Embodiment 2

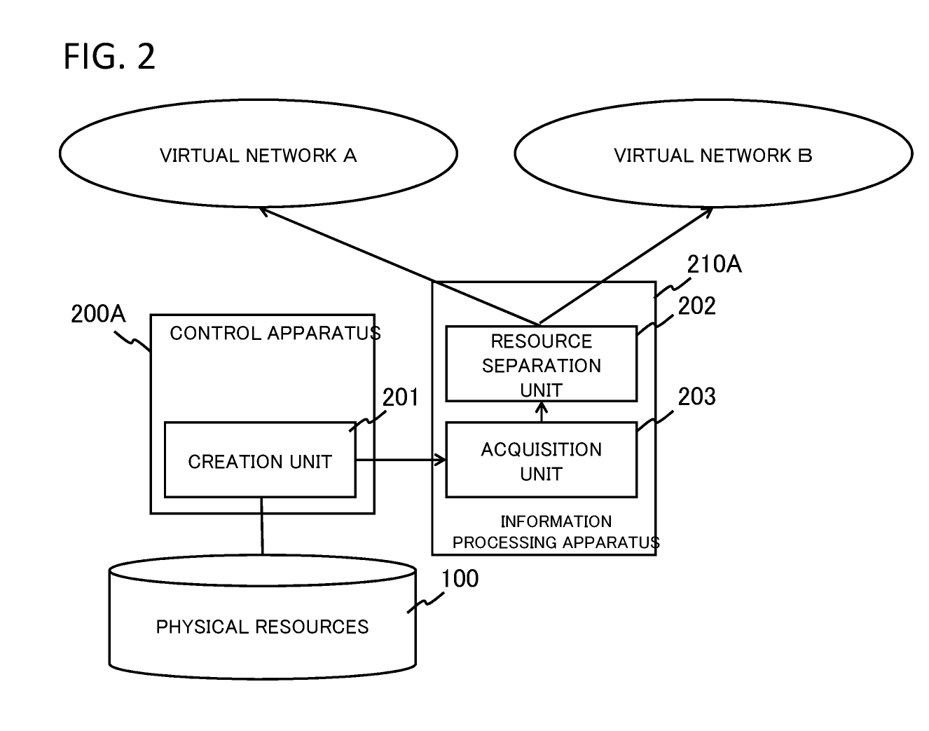

Next, a second example embodiment, in which the apparatus configuration of the first example embodiment of the present disclosure is modified, will be described in detail with reference to the drawings. FIG. 2 is a drawing showing the configuration of the second example embodiment of the present disclosure. FIG. 2 shows a configuration in which a control apparatus 200 A comprising the creation unit 201 and an information processing apparatus 210A comprising the resource separation unit 202 and acquisition unit 203 are connected.

The creation unit 201 of the control apparatus 200A (the first apparatus) of the present example embodiment creates a plurality of virtual networks (the virtual networks A and B in FIG. 1) on the basis of the state of the physical resources 100 as the creation unit 201 of the first example embodiment.

The acquisition unit 203 of the information processing apparatus 210A acquires information of the plurality of virtual networks from the control apparatus 200A (the first apparatus).

The resource separation unit 202 divides the resources allocated to the plurality of virtual networks for each virtual network on the basis of the information acquired by the acquisition unit 203 and displays the resources as necessary.

As described above, the present disclosure can be applied to the configuration in which the information processing apparatus 210A is provided, independent of the control apparatus 200A that creates virtual networks. In addition to the same effects as the first example embodiment, the present example embodiment has an advantage that a single information processing apparatus 210A can acquire information of a plurality of virtual networks from a plurality of control apparatuses 200A.

### Example Embodiment 3

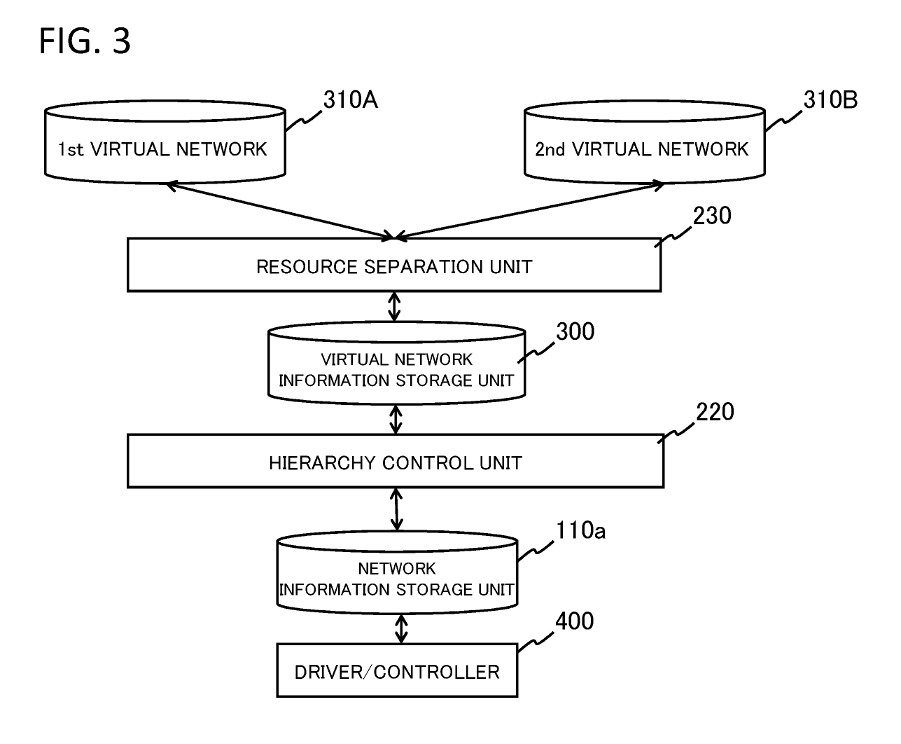

Next, a third example embodiment of the present disclosure will be described in detail with reference to the drawings. FIG. 3 is a drawing showing the configuration of the third example embodiment of the present disclosure. FIG. 3 shows a configuration including a network information storage unit 110a, a hierarchy control unit 220, a virtual network information storage unit 300, a resource separation unit 230 that functions as a display unit and operation reception unit, and a driver/controller 400.

The network information storage unit 110a stores, for instance, topology information of a physical network. More concretely, for instance, information of an MPLS-TP (Multiprotocol Label Switching-Transport Profile) network or a packet forwarding network such as a physical network using an OpenFlow switch is registered in the network information storage unit 110a. The information stored in the network information storage unit 110a is referred to by the driver/controller 400 that controls the physical network and is used to control the physical network.

Further, the network information storage unit 110a stores, for instance, information regarding a physical node. The network information storage unit 110a stores, for instance, a node identifier (for instance node ID=LM1) enabling unique identification of a physical node and a port identifier (for instance port IDs=LP1-11, LP1-12) enabling unique identification of a port held by the physical node, associating the identifiers with each other. Further, the network information storage unit 110a may store the node identifier along with management state information or availability information of the physical node.

Further, the network information storage unit 110a stores, for instance, information regarding a port held by a physical node. The network information storage unit 110a stores the port identifier described above (for instance port IDs=LP1-11, LP1-12) along with maximum bandwidth information, management state information or availability information of the port.

Further, the network information storage unit 110a stores, for instance, information regarding a link (a physical link included in a physical network). The network information storage unit 110a stores, for instance, a link identifier (for instance link ID=LLink1-2) enabling unique identification of a link included in the physical network along with information regarding the link. The information regarding the link includes, for instance, the fact that it is the link between nodes LN1 and LN2 and the link's maximum bandwidth.

The hierarchy control unit 220 functions as virtual network creation unit, referring to the information stored in the network information storage unit 110a, creating/updating a virtual network, and registering the network in the virtual network information storage unit 300.

When creating, for instance, a plurality of virtual networks 310A and 310B (referred to as the “virtual networks 310” hereinafter when each network 310 is not distinguished), the hierarchy control unit 220 allocates physical resources different from each other to each of the plurality of virtual networks 310. The physical resources are at least some of the ports, links (physical links), etc., held by the physical nodes. For instance, the hierarchy control unit 220 allocates a common physical node and physical ports and links different from each other to each of the plurality of virtual networks 310. Further, the hierarchy control unit 220 may allocate physical resources different from each other regarding all the physical resources (physical nodes, ports, and links) included in the physical network to each of the plurality of virtual networks 310.

For instance, the hierarchy control unit 220 may allocate physical resources dedicated to each user of the plurality of virtual networks 310. Since different physical resources are allocated to each user of the virtual networks, each user is able to independently (and exclusively) use some or all of the physical resources and the security of the services (for instance a communication service using a virtual network) provided to the user can be improved.

An identifier (virtual network ID, service ID) enabling unique identification of each of the virtual networks 310 created by the hierarchy control unit 220 is given (set). The unit for giving (setting) the virtual network ID may be, for instance, predetermined control unit (not shown in the drawing), the hierarchy control unit 220, or the resource separation unit 230.

The hierarchy control unit 220 is able to identify the physical resources allocated to the virtual networks 310 using the virtual network ID.

The virtual network information storage unit 300 stores information regarding the virtual networks created by the hierarchy control unit 220. Further, the virtual network information storage unit 300 stores information regarding the virtual networks updated by the hierarchy control unit 220. The virtual network information storage unit 300 also stores information regarding virtual networks updated by the resource separation unit 230. Moreover, the virtual network information storage unit 300 stores the identifiers (virtual network IDs) enabling unique identification of the virtual networks 310 given to (set for) the virtual networks 310. For instance, the virtual network information storage unit 300 stores resources allocated to a virtual network and a virtual network ID of the virtual network, associating the resources with the ID.

The resource separation unit 230 cuts out the plurality of virtual networks 310 (for instance 310A and 310B) from the virtual network information storage unit 300 on the basis of identifiers given by the hierarchy control unit 220 and presents (displays) them. The resource separation unit 230 displays information regarding resources allocated to a virtual network for each of the virtual networks 310. For instance, the resources include ports included in a node. For instance, the resources include links included in a network. The resource separation unit 230 displays, for instance, ports and links allocated to the virtual networks 310 for each of the virtual networks 310.

In the third example embodiment of the present disclosure, for instance, the hierarchy control unit 220 allocates resources different from each other to each of the plurality of virtual networks 310 when creating the plurality of virtual networks 310. Therefore, the resources the resource separation unit 230 displays for each virtual network are different from each other for each virtual network.

Further, for instance, the resource separation unit 230 may display resources (for instance links and ports) allocated to each virtual network and resources (for instance nodes) allocated in common to a plurality of virtual networks for each virtual network. In this case, regarding the resources the resource separation unit 230 displays for each virtual network, links and ports will be different for each virtual network, but for instance nodes will be common.

As described above, for each of virtual networks, the resource separation unit 230 is able to display the topology (for instance nodes, ports and links) of a network allocated to the virtual network, and some or all elements of the topology of the network are different for each of the virtual networks.

For instance, the resource separation unit 230 is able to display resources allocated to the virtual networks 310 for each of the virtual networks 310 independently from each other.

Further, when receiving an operation from a user such as a request to set a flow for the virtual networks 310, the resource separation unit 230 updates the information (information regarding the virtual networks) stored in the virtual network information storage unit 300. The hierarchy control unit 220 performs flow control (S106) such as flow setting on the physical network via the driver/controller 400 on the basis of updated contents in the virtual network information storage unit 300.

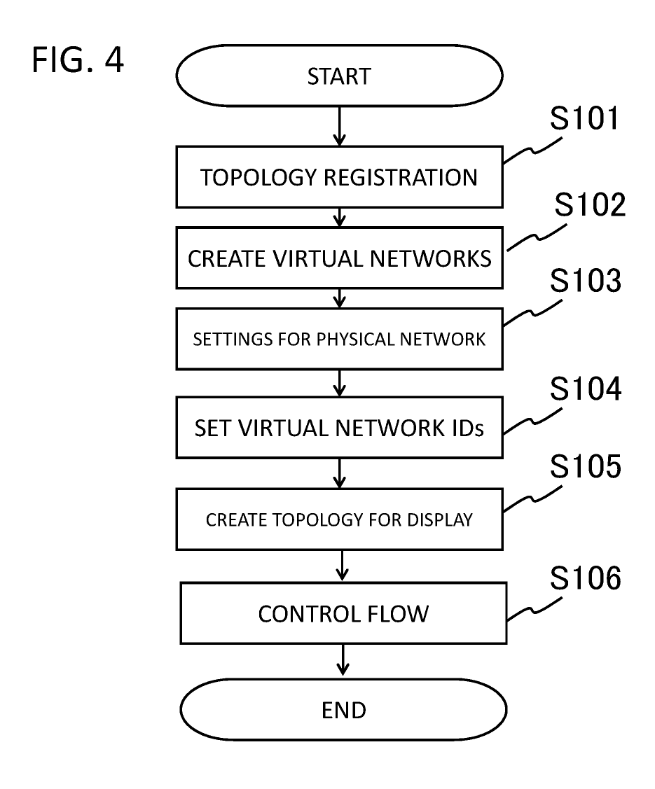

FIG. 4 is a flowchart showing the operation of a control apparatus of the third example embodiment of the present disclosure. The topology information of a physical network is registered in the network information storage unit 110a (step S101).

The hierarchy control unit 220 refers to the network information storage unit 110a and creates the virtual networks 310 (step S102). For instance, the hierarchy control unit 220 adds a virtual link to the virtual networks 310.

In order to realize the created virtual networks 310, the hierarchy control unit 220 performs settings for the physical network through the driver/controller (step S103). For instance, the hierarchy control unit 220 registers a flow for realizing forwarding corresponding to the added virtual link in the physical network and configures a path.

Next, the identifiers (virtual network IDs) enabling unique identification of the virtual networks 310 are given to (set for) the virtual networks 310 created by the hierarchy control unit 220 (step S104). These identifiers may be called service IDs for identifying services from the viewpoint of a virtual network service provider.

The hierarchy control unit 220 is able to create the plurality of virtual networks 310 (for instance 310A and 310B) by repeating the steps S101 to S104 for each of the virtual networks 310. Here, in the first example embodiment of the present disclosure, for instance, the hierarchy control unit 220 allocates physical resources different from each other to each of the plurality of virtual networks 310 when creating the plurality of virtual networks 310 (for instance 310A and 310B). For instance, the hierarchy control unit 220 allocates dedicated resources to each of the plurality of virtual networks 310. As the allocated physical resources, physical ports and links may be directly allocated, or some thereof may be allocated by setting logical paths.

Next, the resource separation unit 230 cuts out the plurality of virtual networks 310 (for instance 310A and 310B) from the virtual network information storage unit 300 on the basis of identifiers given by the hierarchy control unit 220 and presents (displays) them (“Create topology for display” in step S105).

As described, according to the present example embodiment, it becomes possible to present resources allocated to a plurality of users by once creating virtual networks for management/updating (the information regarding the virtual networks in the virtual network information storage unit 300) from the physical network and further cutting out a virtual network for an individual user.

### Example Embodiment 4

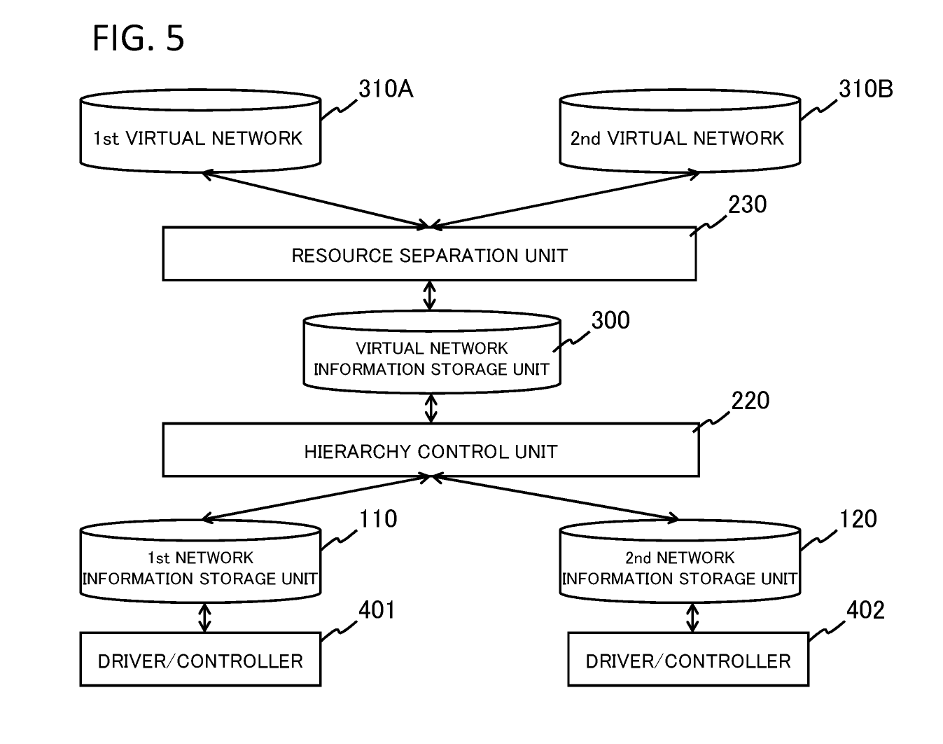

Next, a fourth example embodiment of the present disclosure will be described citing an example of virtual networks constituted using two physical networks. FIG. 5 is a drawing showing the configuration of the fourth example embodiment of the present disclosure.

FIG. 5 shows a configuration that includes first and second network information storage units 110 and 120, the hierarchy control unit 220, the virtual network information storage unit 300, the resource separation unit 230 that functions as a display unit and operation reception unit, and drivers/controllers 401 and 402.

For instance, information of a transport network such as an MPLS-TP (Multiprotocol Label Switching-Transport Profile) is registered in the first network information storage unit 110. The information stored in the first network information storage unit 110 is referred to by the driver/controller 401 that controls a first network and is used to control the first network.

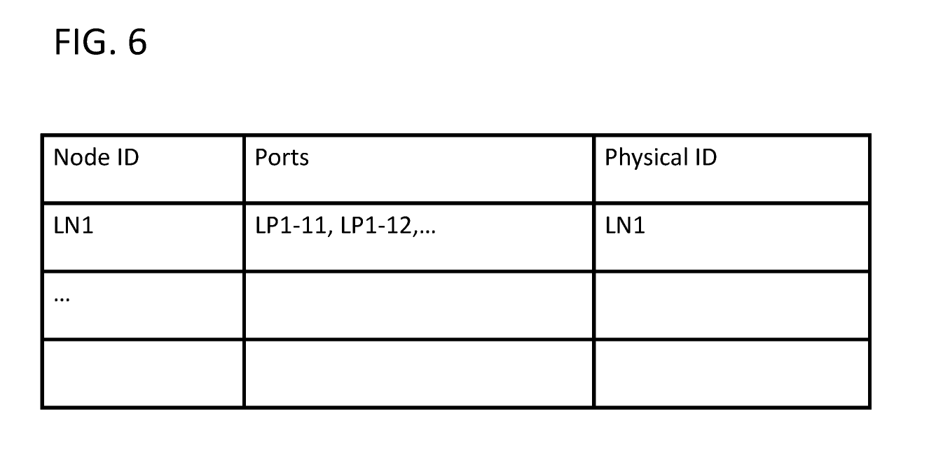

FIG. 6 is an example of node information registered in the first network information storage unit 110. For instance, in the example in FIG. 6, information indicating that a node identified by a node ID=LN1 and a physical ID=LN1 has ports identified by port identifiers (port IDs) LP1-11, LP1-12, etc., is registered. In the example in FIG. 6, the node ID and the physical ID are the same because DPID (DataPathID), which is the physical ID of the node, is used as the node ID. Further, in addition to the information shown in FIG. 6, information such as node management state information (UP/DOWN) or availability (UP/DOWN) may be provided.

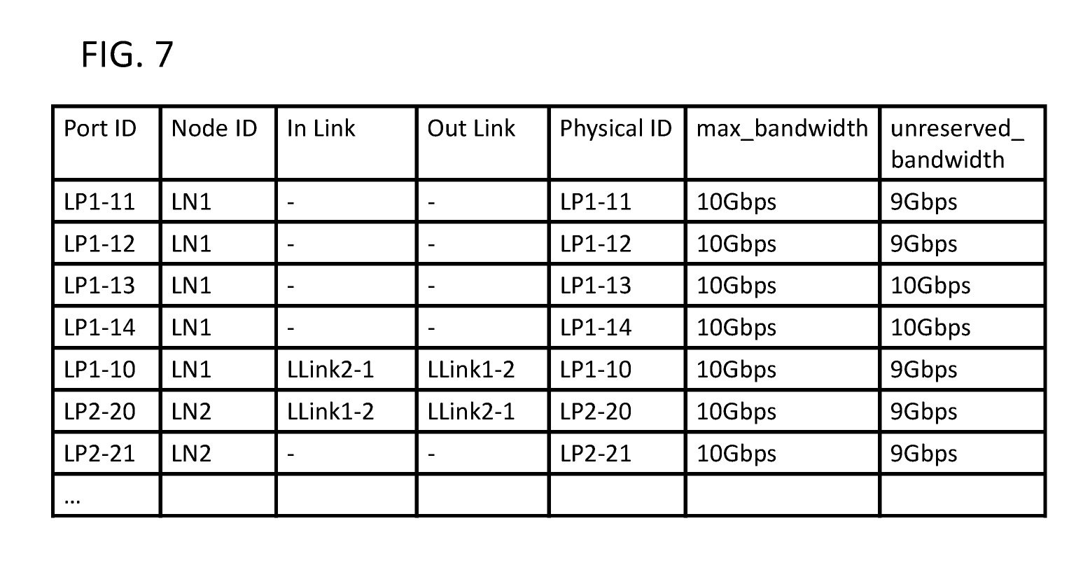

FIG. 7 is an example of port information registered in the first network information storage unit 110. For instance, in the example in FIG. 7, information of ports identified by port identifiers such as the port IDs=LP1-11, LP1-12, etc., is registered. For instance, information indicating that the port of the port ID=LP1-11 is a port of the node ID=LN1, and the maximum bandwidth (max_bandwidth) and the unreserved bandwidth (unreserved_bandwidth) of the port is stored. Further, InLink is a field storing the identifier of a link entering into the port, and OutLink is a field storing the identifier of a link going out of the port. Further, in addition to the information shown in FIG. 7, information such as port management state information (UP/DOWN) or availability (UP/DOWN) may be provided.

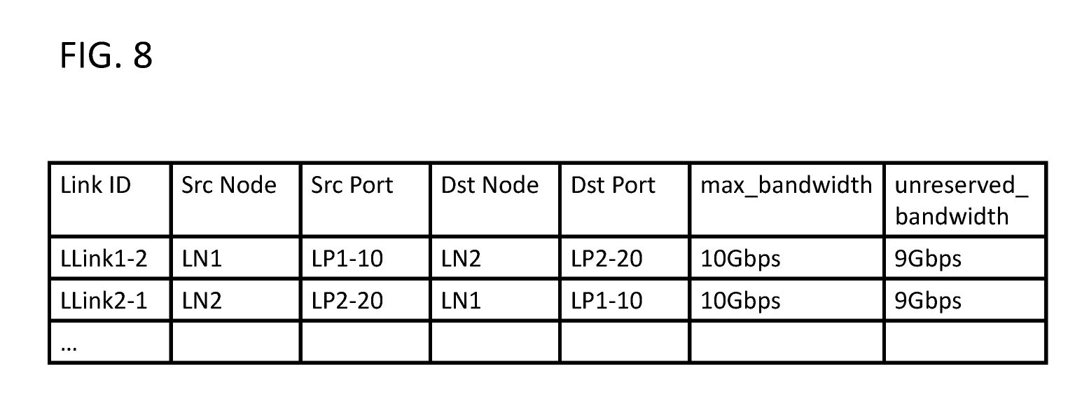

FIG. 8 is an example of link information registered in the first network information storage unit 110. For instance, in the example in FIG. 8, information of links identified by link identifiers such as the link ID=LLink1-2 is registered. For instance, information indicating that the link of the link ID=LLink1-2 is a link between the nodes LN1 and LN2, the port ID of the endpoint port, and the maximum bandwidth (max_bandwidth) and the unreserved bandwidth (unreserved_bandwidth) of the link is stored. Further, in addition to the information shown in FIG. 8, information such as the availability (UP/DOWN) of the link, link cost, and latency may be provided.

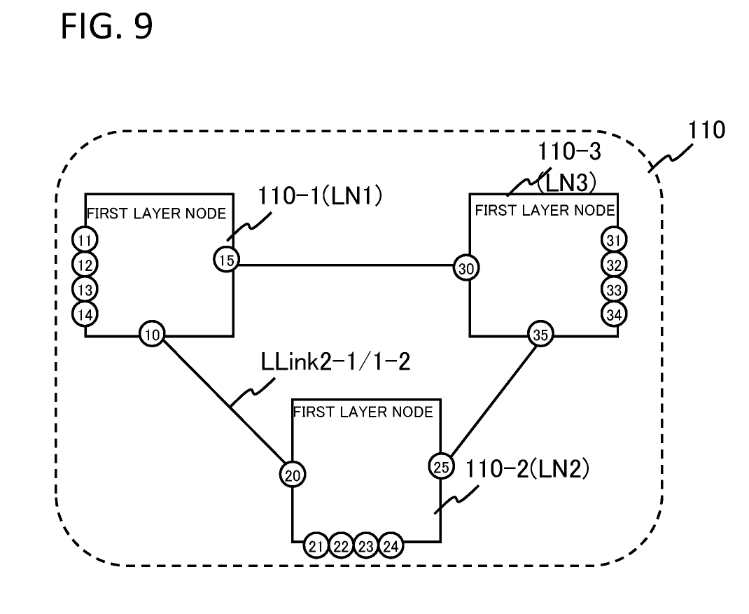

FIG. 9 illustrates the information registered in the first network information storage unit 110 as a topology.

In the second network information storage unit 120, information of a network in a layer higher than the network stored in the first network information storage unit 110 is registered. For instance, information of a packet forwarding network such as a network using an OpenFlow switch is registered. The information stored in the second network information storage unit 120 is referred to by the driver/controller 402 that controls the second network and is used to control the second network.

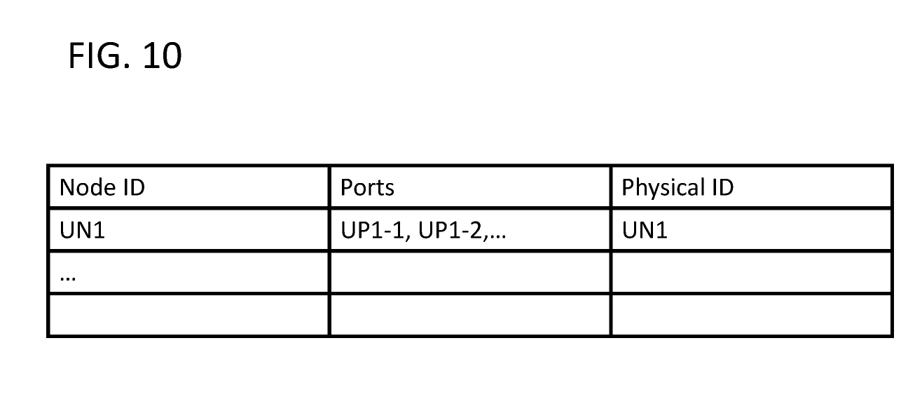

FIG. 10 is an example of node information registered in the second network information storage unit 120. For instance, in the example in FIG. 10, information indicating that a node identified by a node ID=UN1 and a physical ID=UN1 has ports identified by port identifiers (port IDs) UP1-11, UP1-12, etc., is registered. In the example in FIG. 10, the node ID and the physical ID are the same because the physical ID of the node (for instance DPID (DataPathID)) is used as the node ID. Further, in addition to the information shown in FIG. 10, information such as node management state information (UP/DOWN) or availability (UP/DOWN) may be provided.

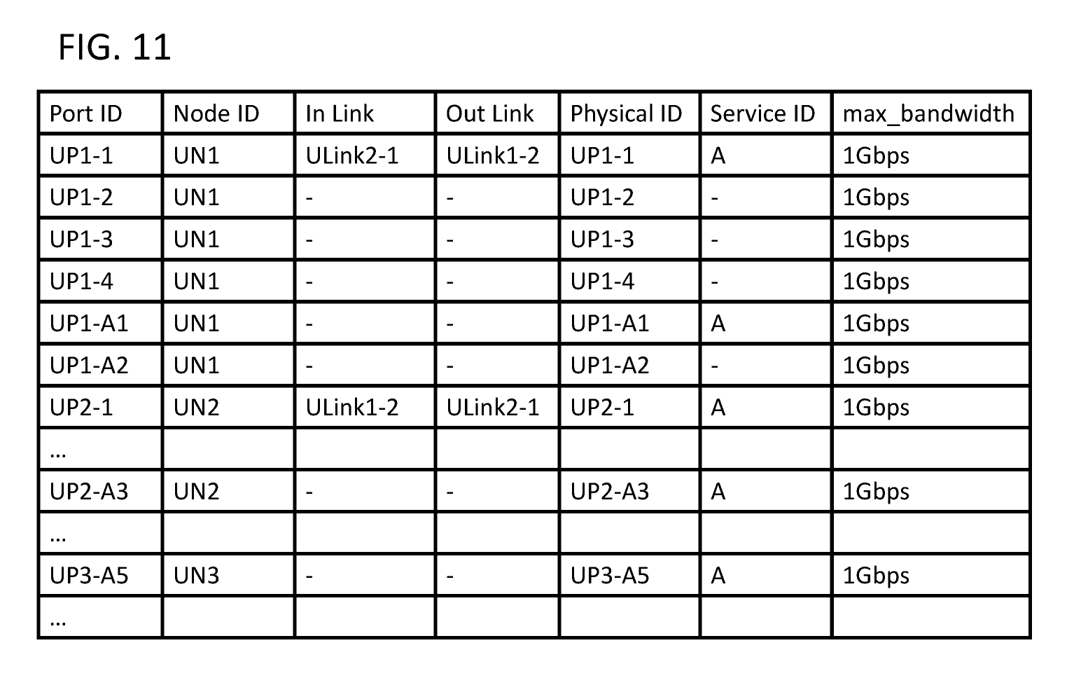

FIG. 11 is an example of port information registered in the second network information storage unit 120. For instance, in the example in FIG. 11, information of ports identified by port identifiers such as port IDs=UP1-1, UP1-2, etc., is registered. For instance, information indicating that the port of the port ID=UP1-1 is a port of the node ID=UN1, the port is connected to link IDs=ULink2-1 and ULink1-2, and that the port's maximum bandwidth (max_bandwidth) is 1 Gbps is stored. Further, Service ID field in FIG. 11 is a field for setting a user (service) ID to which the port is allocated. InLink is a field storing the identifier of a link entering into the port, and OutLink is a field storing the identifier of a link going out of the port. Further, in addition to the information shown in FIG. 11, information such as port management state information (UP/DOWN), availability (UP/DOWN), or unreserved bandwidth may be provided.

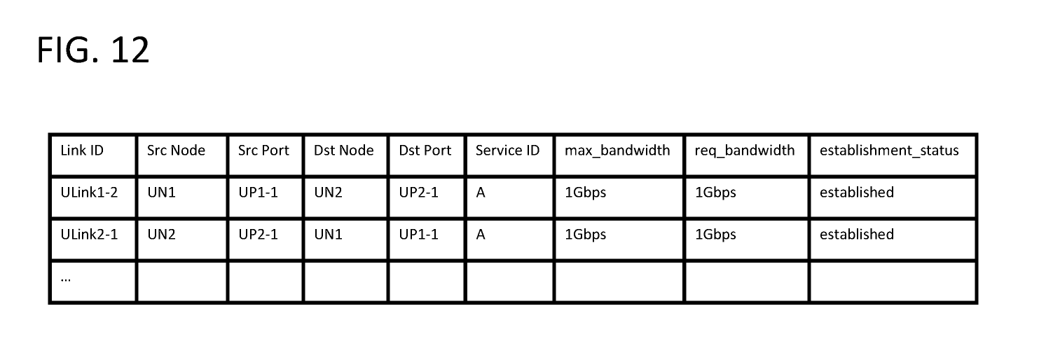

FIG. 12 is an example of link information registered in the second network information storage unit 120. For instance, in the example in FIG. 12, information of links identified by link identifiers such as the link ID=ULink1-2 is registered. For instance, information indicating that the link of the link ID=ULink1-2 is a link between the nodes UN1 and UN2, the port ID of the endpoint port, and that the link's maximum bandwidth (max_bandwidth) is 1 Gbps is stored. Service ID field in FIG. 12 is a field for setting a user (service) ID to which the link is allocated. Further, Establishment_status field is a field for setting whether or not a flow corresponding to the link is set in the first network. In the example of FIG. 12, it is “Established (settings completed),” but “Establishing” means that it is being set and “Failed” setting has failed. Further, in addition to the information shown in FIG. 12, information such as the availability of the link (UP/DOWN), link cost, and required latency bandwidth may be provided.

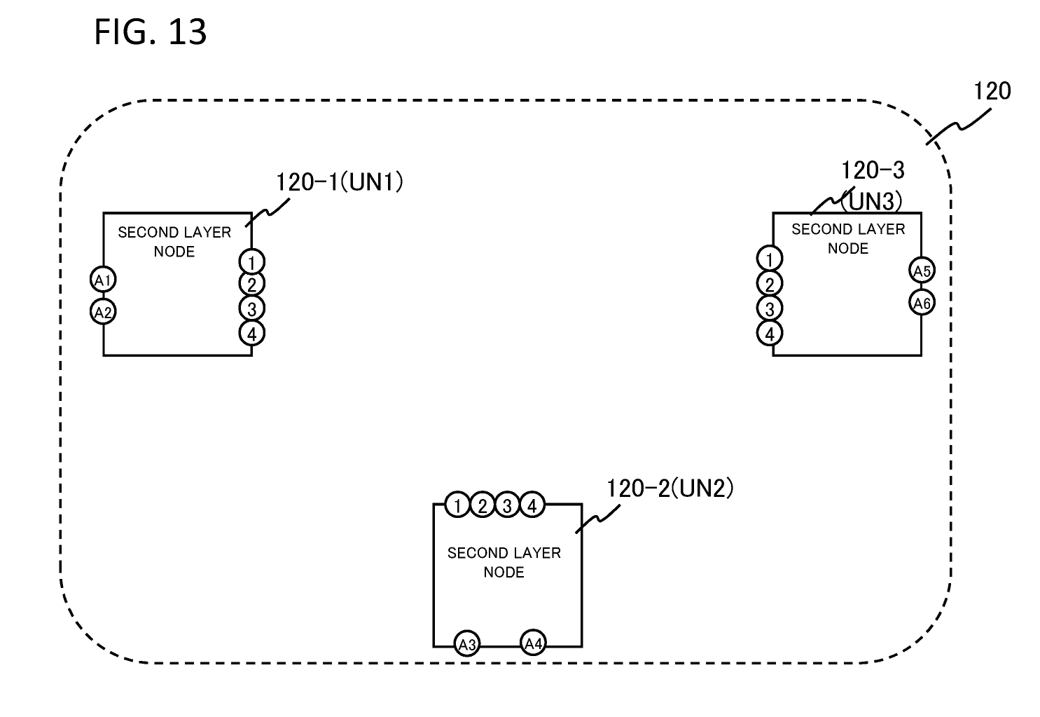

FIG. 13 illustrates the information registered in the second network information storage unit 120 as a topology. It is assumed that no link or service ID (virtual network ID) is set between UN1 and UN2 in FIG. 13.

In the examples of FIGS. 6 to 8 and FIGS. 10 to 12, the network information is stored in three tables, dividing the information into the node information, port information, and the link information, however, these pieces of information may be stored in one single table and any other information such as maximum bandwidth and unreserved bandwidth may be managed in a different table.

The hierarchy control unit 220 refers to the information stored in the first and the second network information storage units 110 and 120, creates/updates integrated virtual networks, and registers the networks in the virtual network information storage unit 300. Further, the layerizer, a network operator that maps a plurality of network layers into a single network instance is known. Therefore, the hierarchy control unit 220 could be a form of the creation unit for mapping a plurality of network layer links to present them as a single virtual network. In this sense, the hierarchy control unit may be called a link layerizer.

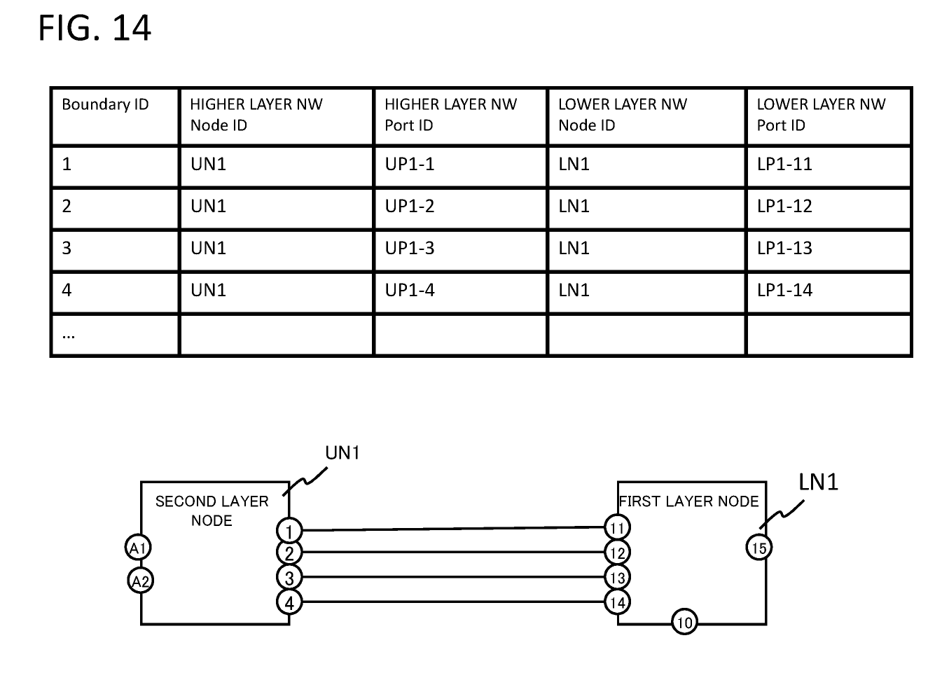

A table in the upper part of FIG. 14 is an example of link boundary information set in the hierarchy control unit 220. The lower part of FIG. 14 illustrates the information set in the table in the upper table of FIG. 14. For instance, in the example of FIG. 14, the port UP1-1 of the node UN1 in the second network (in the higher layer) and the port LP1-11 of the node LN1 in the first network (in the lower layer) form a boundary between the two networks. The hierarchy control unit 220 creates an integrated virtual network on the basis of such information.

Further, when a link or flow is registered in the virtual network held by the virtual network information storage unit 300, the hierarchy control unit 220 refers to the link boundary information and the first and the second network information storage units 110 and 120, and instructs the drivers/controllers 401 and 402 that control each physical network. For instance, when a link is configured in the virtual network, the hierarchy control unit 220 adds the link in the corresponding table of the second network information storage unit 120 on the basis of the settings, and configures a corresponding flow in the first network information storage unit 110. As a result, an environment in which networks across a plurality of layers are treated as if they are a single network is provided. This operation will be described in detail below.

Further, it is preferable that, when creating a virtual network, the hierarchy control unit 220 of the present example embodiment create a virtual network in which duplicate links can configured in the same section so as to be able to allocate dedicated network resource to a virtual network user (refer to the lower part of FIG. 14). When resources are allocated to a user of the virtual network 310, the hierarchy control unit 220 gives an identifier (virtual network or service ID) to the resources.

Further, the hierarchy control unit 220 is able to express the created network (provided network) using the node information, port information, and the link information shown in FIGS. 10 to 12. Note that their roles are different in the sense that the information held by the second network information storage unit 120 is referred to by the drivers/controllers 401 and 402, and the information held by the virtual network information storage unit 300 is referred to by the resource separation unit 230.

The resource separation unit 230 cuts out the virtual networks 310A and 310B allocated to each of a plurality of users from the virtual network information storage unit 300 on the basis of the identifiers given by the hierarchy control unit 220 and presents the networks. Further, when receiving an operation such as a flow setting request from a user based on the virtual networks 310A and 310B, the resource separation unit 230 updates the corresponding information in the virtual network information storage unit 300. The hierarchy control unit 220 configures a flow according to the user's intention on the basis of the updated contents in the virtual network information storage unit 300.

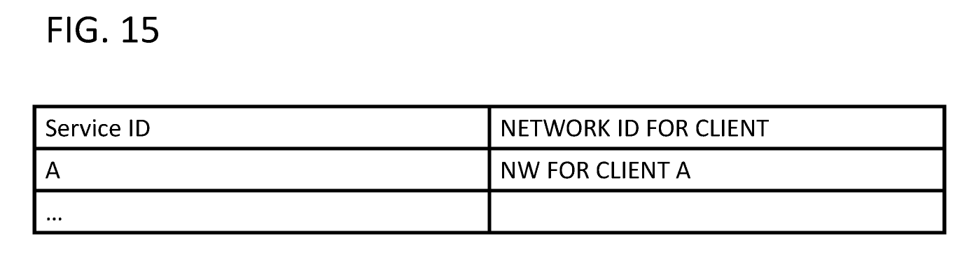

FIG. 15 is a drawing showing an example of service information held by the resource separation unit 230. In the example of FIG. 15, a service ID=A is given to a NW (virtual network) providing service for a client A.

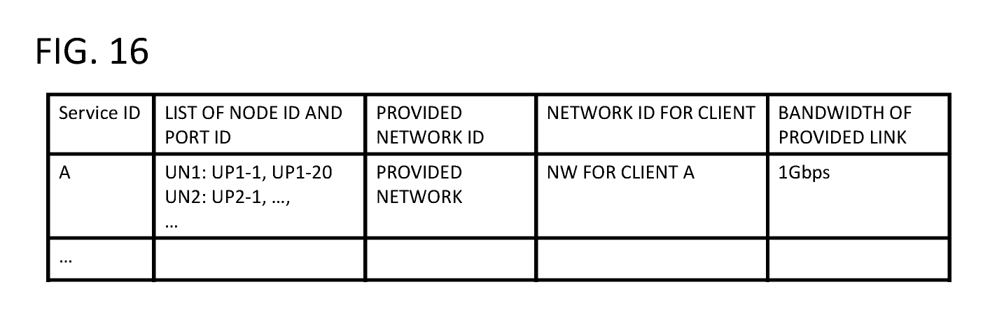

FIG. 16 is a drawing showing an example of service allocation information held by the resource separation unit 230. In the example of FIG. 16, the fact that the resources in the node/port ID list field are allocated to the service ID=A, a provided network ID (ID of the virtual network provided in the service), a network ID shown to the client (user), and the bandwidth of the provided link are registered.

Further, each unit (processing unit) of the control apparatus and the information processing apparatus may be realized by a computer program that has a computer constituting these apparatuses execute each processing described above using the hardware thereof (processor, memory, storage, etc.).

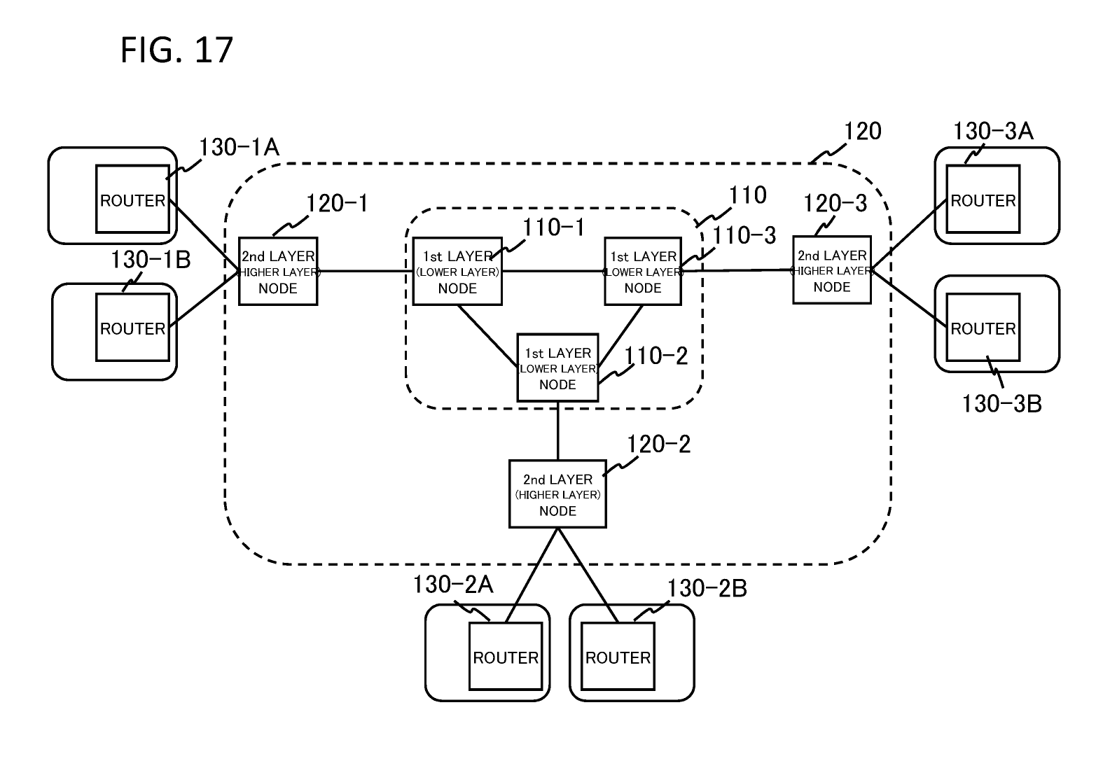

Next, the operation of the present example embodiment will be described more concretely using an example of a simple virtual network configuration. FIG. 17 is a drawing showing an example of a network configuration for explaining the operation of the present example embodiment. FIG. 17 shows a configuration in which first layer (lower layer) nodes 110-1 to 110-3 connected to each other and second layer (higher layer) nodes 120-1 to 120-3 between the first layer (lower layer) nodes 110-1 to 110-3 and users' routers 130-1A to 130-3B are provided. The first layer (lower layer) nodes 110-1 to 110-3 correspond to the nodes LN1 to LN3 in the first network (in the lower layer) and the second layer (higher layer) nodes 120-1 to 120-3 correspond to UN1 to UN3 in the second network.

Further, in the description below, it is assumed that the routers 130-1A, 130-2A, and 130-3A are the client A (user A)'s devices, and the routers 130-1B, 130-2B, and 130-3B are the client B (user B)'s devices.

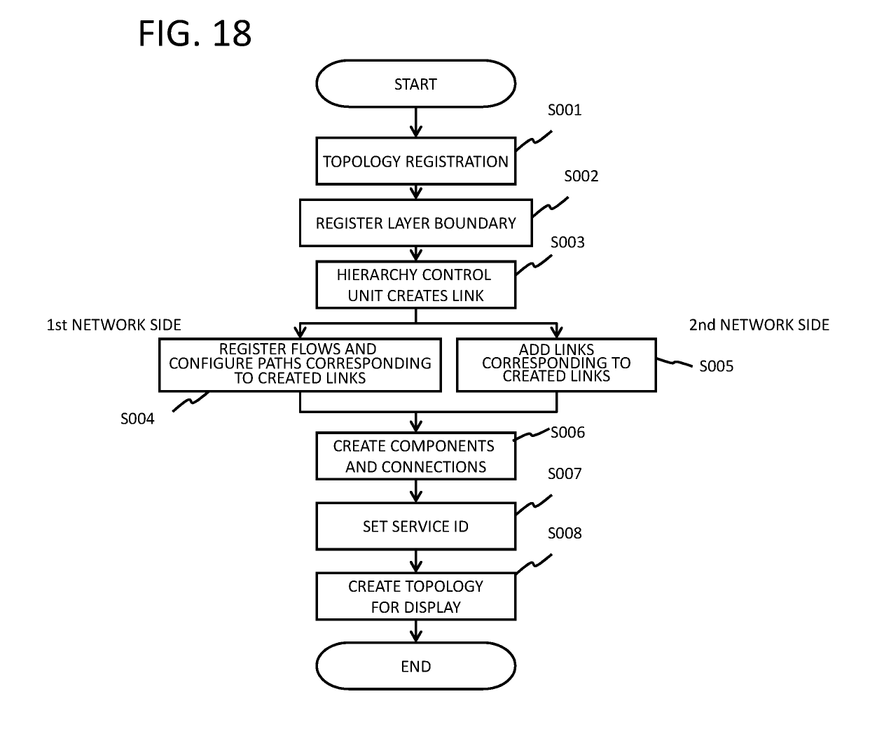

FIG. 18 is a flowchart showing the operation (preparation processing) of the control apparatus of the fourth example embodiment of the present disclosure. In FIG. 18, a network topology is registered in the first and the second network information storage units 110 and 120 (step S001). In the description below, it is assumed that the topology information shown in FIGS. 6 to 13 has been registered.

Next, link boundary information is registered in the hierarchy control unit 220 (step S002). In the description below, it is assumed that the link boundary information shown in FIG. 12 has been registered.

Next, the hierarchy control unit 220 creates a virtual network, and for instance, links are added in the virtual network in order to provide a service to the client (user) A (step S003).

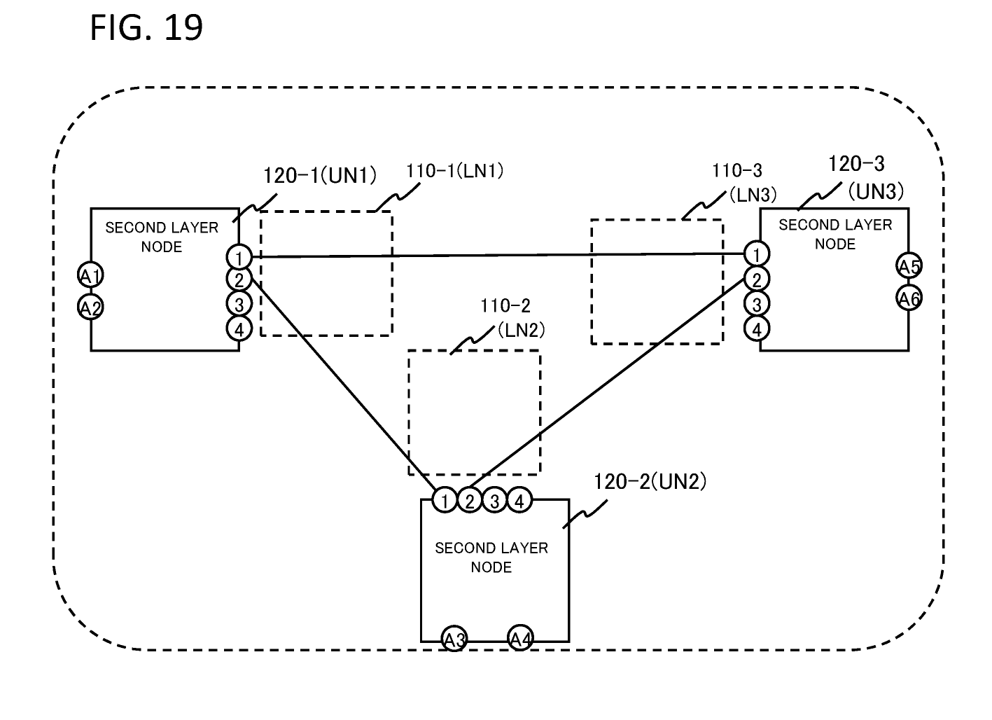

FIG. 19 is a drawing showing a state in which links are created for the client A (user A). In the example of FIG. 19, the ports 1 and 2 of the second layer (higher layer) nodes 120-1 (UN1) to 120-3 (UN3) are allocated and linked.

Once the links shown in FIG. 19 are configured, the hierarchy control unit 220 first registers flows for achieving forwarding using the links and configures paths among the first layer (lower layer) nodes 110-1 to 110-3 in the first network on the basis of the link boundary information (step S004).

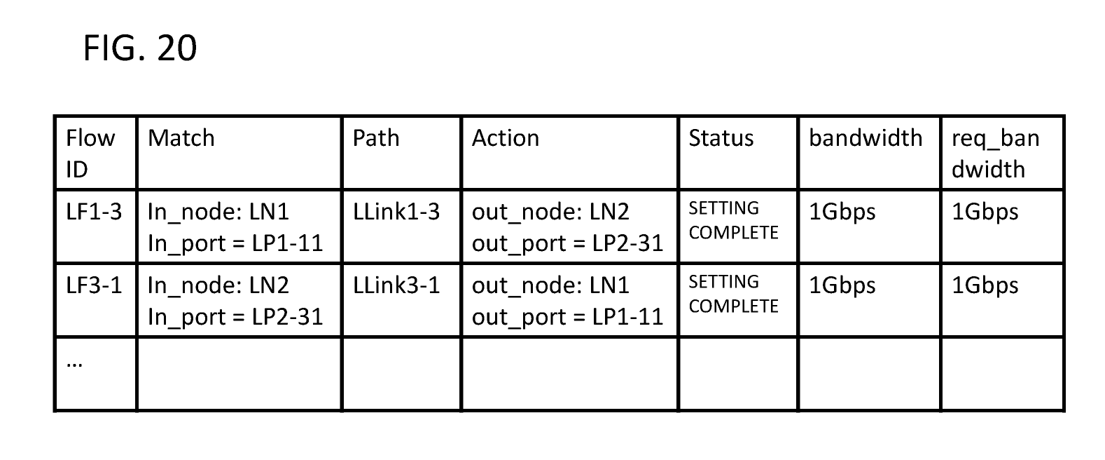

FIG. 20 is a drawing showing an example of flow information corresponding to the link between LN1 and LN2 in FIG. 19. In the example of FIG. 20, a flow (flow ID=LF1-3) that outputs a packet of a path LLink1-3 from LN1 as the start point to LN3 as the end point from a port 31 of the first layer (lower layer) node 110-3 (LN3) is configured at a port 10 of the first layer (lower layer) node 110-1 (LN1). In the example of FIG. 20, a flow (flow ID=LF3-1) in the opposite direction of the flow (flow ID=LF1-3) is also configured. Similarly, the same flows are configured between the first layer (lower layer) nodes 110-1 (LN1) and 110-2 (LN2) and between the first layer (lower layer) nodes 110-2 (LN2) and 110-3 (LN3).

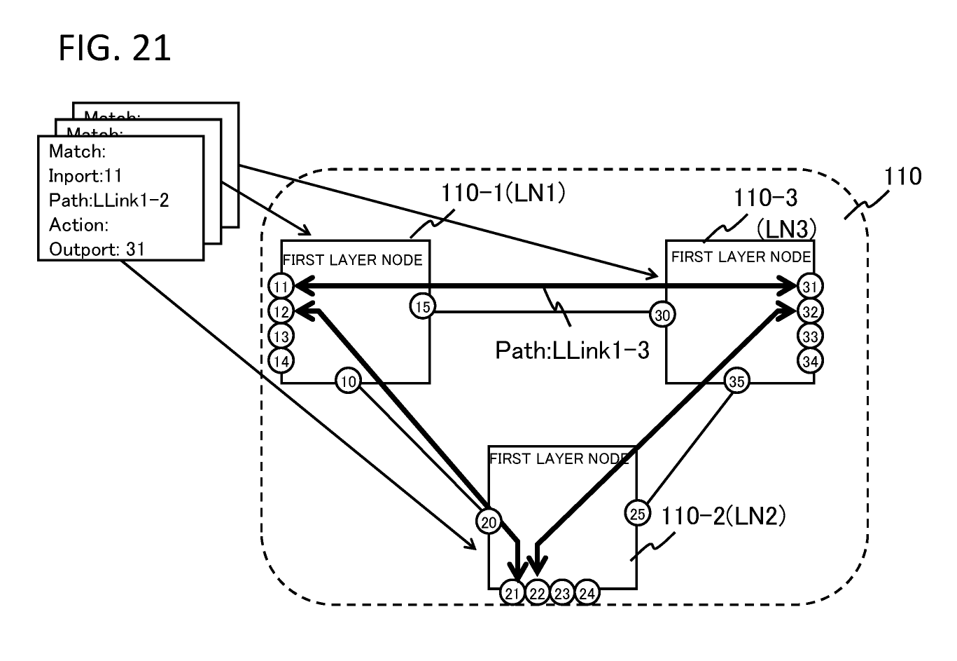

FIG. 21 is a drawing illustrating the flow information described above over FIG. 9. By registering such flows in the first layer (lower layer) nodes 110-1 to 110-3, forwarding along the links in the virtual network created in the step S003 is achieved. Further, a packet outputted from a port outside the first layer (lower layer) nodes 110-1 to 110-3 is received by the second layer (higher layer) nodes 120-1 to 120-3 according to the layer boundary information.

Further, the hierarchy control unit 220 adds links corresponding to the links in FIG. 19 among the second layer (higher layer) nodes 120-1 to 120-3 in the second network according to the link configuration shown in FIG. 19 (step S005). This link information is the same as the link information shown in FIG. 12.

Then, components and connections are created via the resource separation unit 230 (step S006), and a service ID is set (step S007). More concretely, a service ID is set in the Service ID field in the tables shown in FIGS. 11 and 12.

After the processes above have been completed, the topology of the virtual network for the client A (user A) can be created (step S008). More concretely, the resource separation unit 230 extracts the information of the links and ports having the service ID=A and the nodes related thereto from the virtual network information storage unit 300 and creates the topology of the virtual network for the client A (user A).

Further, in the flowchart shown in FIG. 18, the process of registering flows and configuring paths (the step S004) and the process of adding links corresponding to the links in FIG. 19 (the step S005), both performed by the hierarchy control unit 220, may be done in parallel, or one of the processes may be started first before the other process is started.

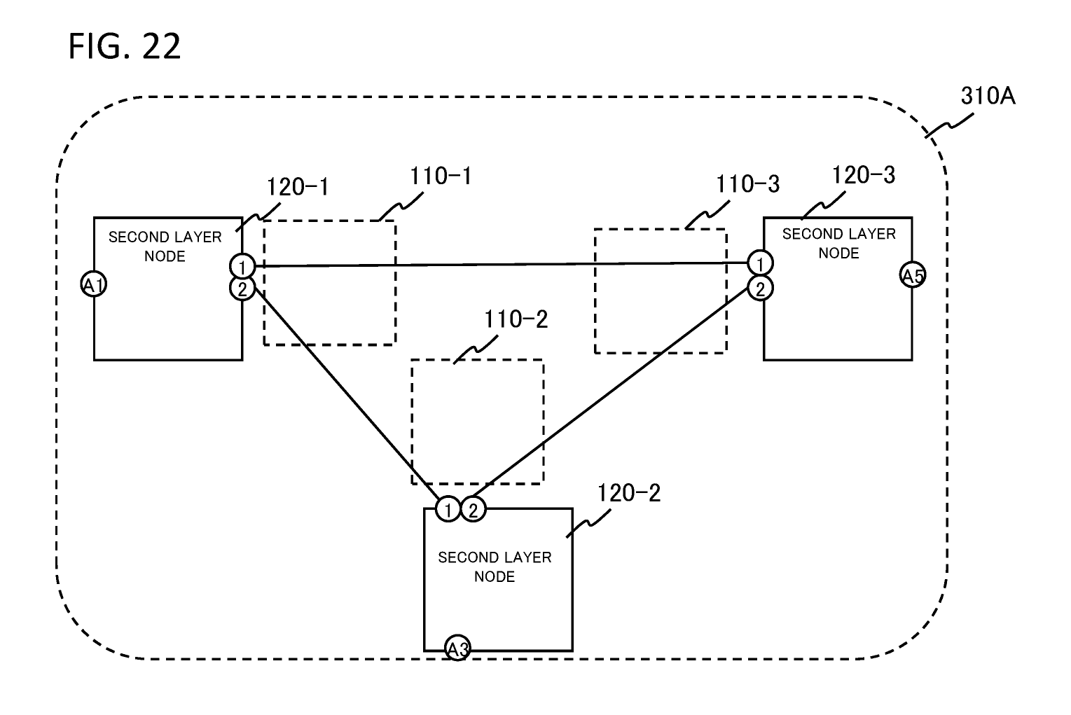

FIG. 22 is a drawing showing an example of the topology of the virtual network 310A for the client A (user A). By referring to the topology of the virtual network, the client A (user A) is able to recognize that physical ports A1, A3, and A5 of the second layer (higher layer) nodes 120-1 to 120-3 and port links connecting these nodes are allocated to him.

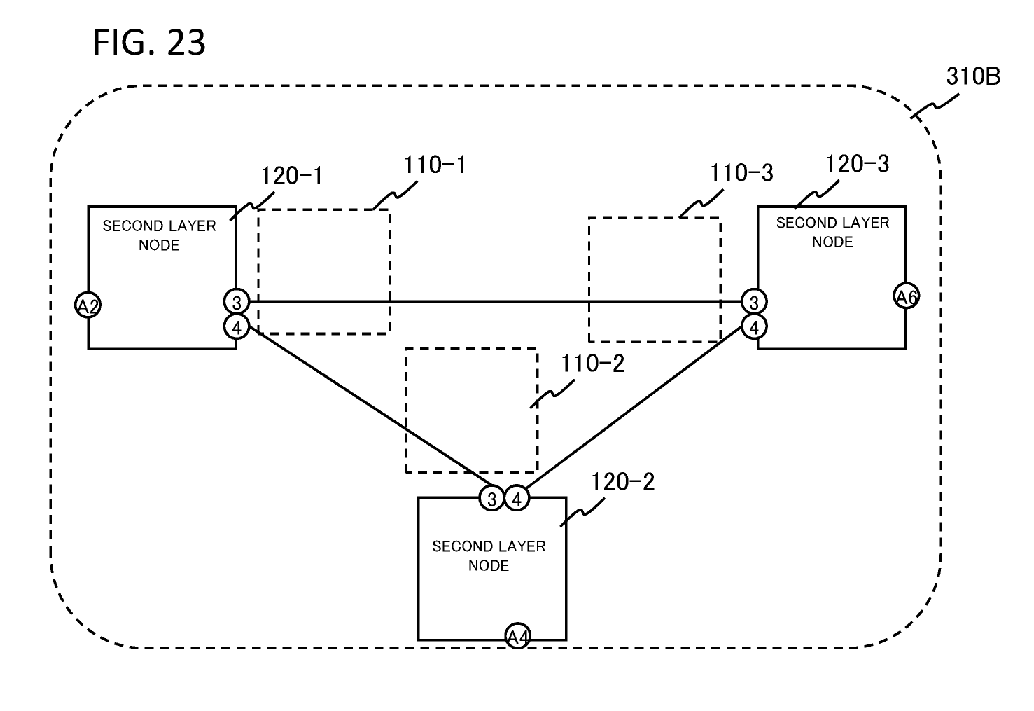

By repeating the processes described above, it becomes possible to allocate physical network resources to the client B (user B), create a virtual network for the client B (user B), and present the dedicated virtual network to the client B (user B). FIG. 23 is a drawing showing an example of the topology of the virtual network 310B for the client B (user B). By referring to the topology of the virtual network, the client B (user B) is able to recognize that ports A2, A4, and A6 of the physical second layer (higher layer) nodes 120-1 to 120-3 and port links connecting these nodes are allocated to him.

Next, how a client (user) who refers to the topology of a virtual network, such as the one described above, sets a flow and has the second layer (higher layer) nodes 120-1 to 120-3 operate as layer 3 switches will be described.

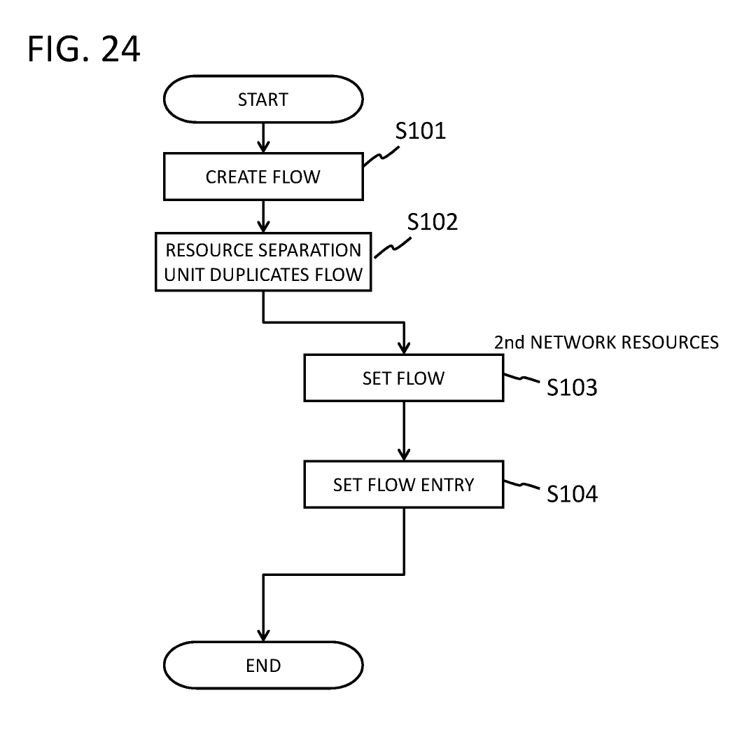

FIG. 24 is a flowchart showing the operation (flow addition process) of the control apparatus of the fourth example embodiment of the present disclosure. First, we will assume that the router 130-1A shown in FIG. 17 has acquired information of a router connected to a communication partner using the BGP (Border Gateway Protocol), etc. Here, an example in which the client A (user A) sets a flow for forwarding a packet sent from the router 130-1A or 130-2A to the router 130-3A will be described.

First, a flow for forwarding a packet sent from the router 130-1A or 130-2A to the router 130-3A via the resource separation unit 230 is set (step S101). For instance, the flow setting operation may be accepted via a GUI (Graphical User Interface) using the topology of the virtual network shown in FIG. 22. Needless to say, the input may be accepted via a command line interface.

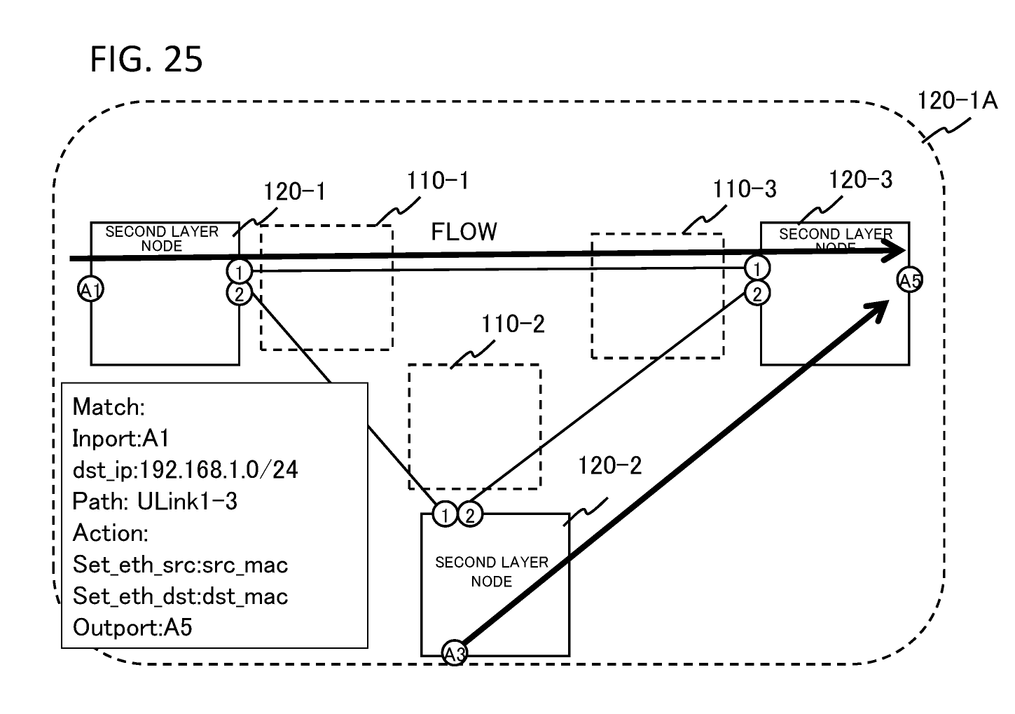

Upon receiving the flow setting operation, the resource separation unit 230 duplicates the received flow information and registers the information in the virtual network information storage unit 300 (step S102). FIG. 25 is an example of a flow set by the client A (user A). In the example of FIG. 25, for instance, a flow in which, when a packet having a destination IP address 192.168.1.0/24 is received at the port A1 of the second layer (higher layer) node 120-1, the source MAC address and destination MAC address are rewritten and the packet is outputted from the port A5 of the second layer (higher layer) node 120-1 is set.

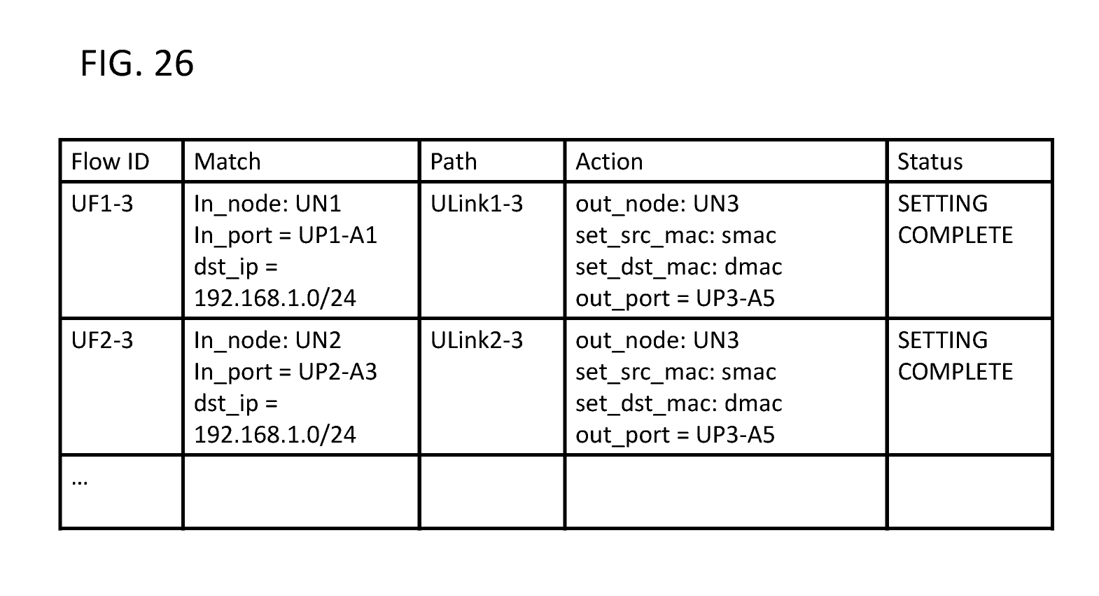

After the flow information above is registered in the virtual network information storage unit 300, the hierarchy control unit 220 registers flow information corresponding to the registered flow information in the second network information storage unit 120 (step S103). FIG. 26 is a drawing showing an example of the flow information set in the second network information storage unit 120. In the example of FIG. 26, a flow (flow ID=UF1-3) in which a packet having a path ULink1-3 from UN1 as the start point to UN3 as the end point is outputted from the port A5 of the second layer (higher layer) node 120-3 (UN3) is set at the port A1 of the second layer (higher layer) node 120-1 (UN1). In the example of FIG. 26, a flow (flow ID=UF2-3) in which a packet having a path ULink2-3 from UN2 as the start point to UN3 as the end point is outputted from the port A5 of the second layer (higher layer) node 120-3 (UN3) is also set at the port A3 of the second layer (higher layer) node 120-2 (UN2).

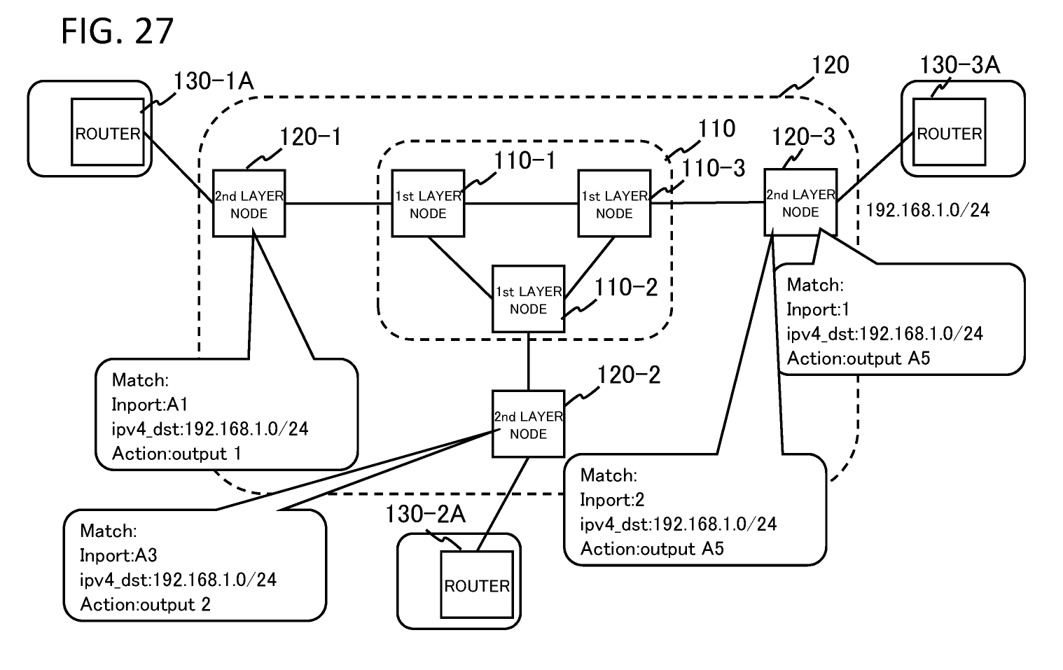

Once the flows above have been set, the driver/controller 402 physically controls the second layer (higher layer) nodes 120-1 (UN1) to 120-3 (UN3). FIG. 27 is a drawing showing an example of control information set in the second layer (higher layer) nodes 120-1 (UN1) to 120-3 (UN3). In the example of FIG. 27, when receiving a packet with the destination IP address 192.168.1.0/24 at the port A1, the second layer (higher layer) node 120-1 (UN1) outputs the packet from the port 1 (UP1-1 in FIG. 11) allocated to the client A (user A). The packet outputted from the port 1 (UP1-1 in FIG. 11) of the second layer (higher layer) node 120-1 is received by a port 11 of the first layer (lower layer) node 110-1 and outputted from the port 31 of the first layer (lower layer) node 110-3 along the lower flow shown in FIG. 20. When receiving a packet with the destination IP address 192.168.1.0/24 at the port 1 allocated to the client A (user A), the second layer (higher layer) node 120-3 outputs the packet from the port A5 (UP3-A5 in FIG. 11) allocated to the client A (user A). As described, physical forwarding along the flows in the virtual network shown in FIG. 25 is achieved.

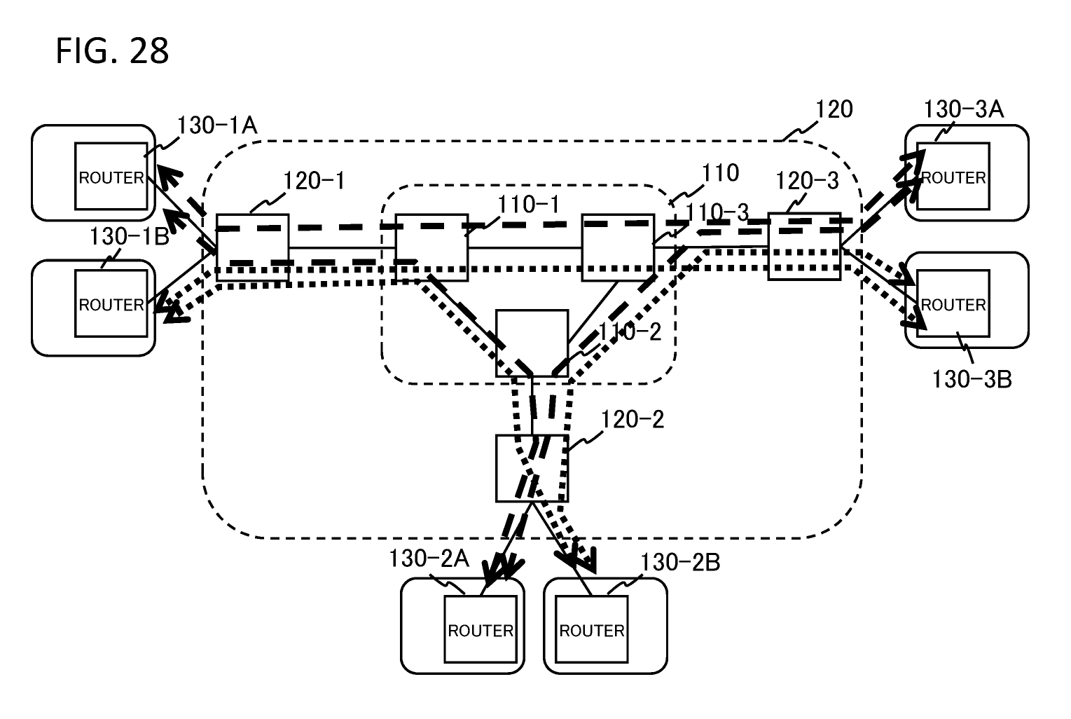

By having the client A (user A) and the client B (user B) perform similar processes for both directions, flows indicated by arrow lines in FIG. 28 (dashed lines indicate the user A; dotted lines the user B) can be set for each user. As described above, the links between the second layer (higher layer) nodes and the first layer (lower layer) nodes are physically and logically separated and that is the case in the virtual networks as well. Therefore, looking at the presented virtual network, a client (user) is able to specify where a flow should go through and utilize the physical links as specified. At the same time, this also means that it is possible to manage the traffic of each client (user) using different pieces of control information (flow entries) in a second layer (higher layer) node.

Further, while the registration of a flow is explained in the example above, a flow can be deleted by applying an operation specified for the virtual networks to the first and the second networks in a similar procedure. A flow can be changed by combining the registration and deletion of a flow described above. In other words, the resource separation unit 230 of the present example embodiment also functions as flow operation reception unit for receiving a flow operation from a user.

The example embodiments of the present invention have been described above, however, the present invention is not limited to the example embodiments described and further modifications, substitutions, and adjustments can be added within the scope of the basic technological concept of the present invention. For instance, the network configurations, the configuration of each element, and the message expressions shown in the drawings are merely examples to facilitate understanding of the present invention without being limited thereto.

For instance, in the fourth example embodiment, it is possible to reflect any update on the first and the second network information storage units 110 and 120 on the configuration of the virtual networks and to perform necessary updates on the first and the second network information storage units 110 and 120 after a virtual node is added to the virtual networks.

Finally, preferred modes of the present invention will be summarized.

### [Mode 1]

(Refer to the control apparatus according to the first aspect.)

### [Mode 2]

The control apparatus according to Mode 1, wherein

the creation unit creates a virtual network by allocating physical resources different from physical resources allocated to another virtual network.

### [Mode 3]

The control apparatus according to Mode 1 or 2, wherein

the physical resources include a port of a physical node, and
the creation unit creates the virtual network by allocating a port realized using the physical node and different from another port allocated to another virtual network.

### [Mode 4]

The control apparatus according to any one of Modes 1 to 3, wherein

the physical resources include a physical link that realizes at least part of a path in a physical network, and
the creation unit creates the virtual network by allocating a physical link that shares at least part of the path and that is different from another physical link allocated to another virtual network.

### [Mode 5]

The control apparatus according to any one of Modes 1 to 4, wherein

a virtual network created by the creation unit has an identifier for identifying the virtual network, and
the resource separation unit has resources allocated to the virtual network corresponding to the identifier displayed.

### [Mode 6]

The control apparatus according to any one of Modes 1 to 5, wherein

the creation unit creates a virtual network topology in which a first physical network and a second physical network in a layer higher than the first physical network are integrated on the basis of the topologies of the first and the second networks, and
the resource separation unit displays the topology of a virtual network having a specified identifier from the virtual network topology.

### [Mode 7]

The control apparatus according to any one of Modes 1 to 6, wherein

the creation unit creates a virtual network realized over a plurality of physical networks in layers different from each other on the basis of information regarding the topology of the plurality of physical networks.

### [Mode 8]

The control apparatus according to Mode 6 or 7 further comprising a flow operation reception unit configured to receive a flow operation from a user on the basis of the content displayed by the resource separation unit, wherein

the creation unit identifies endpoints of the first and the second physical networks corresponding to the flow operation received by the flow operation reception unit and controls the first and the second physical networks.

### [Mode 9]

(Refer to the information processing apparatus according to the second aspect.)

### [Mode 10]

(Refer to the method for presenting virtual network according to the third aspect.)

### [Mode 11]

(Refer to the computer program according to the fourth aspect.) Further, as Mode 1, Modes 9 to 11 can be similarly developed into Modes 2 to 8.

Further, the disclosure of each Patent Literature cited above is incorporated herein in its entirety by reference thereto. It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications. Particularly, the ranges of the numerical values used in the present description should be interpreted as a numeric value or small range example included in these ranges even in cases where no explanation is provided.

1. A control apparatus comprising:
a creation unit configured to create a virtual network on the basis of the state of physical resources; and
a resource separation unit configured to separate resources allocated to the virtual network created by the creation unit for each virtual network.

2. The control apparatus according to claim 1, wherein
the creation unit creates a virtual network by allocating physical resources different from physical resources allocated to another virtual network.

3. The control apparatus according to claim 1, wherein
the physical resources include a port of a physical node, and
the creation unit creates the virtual network by allocating a port realized using the physical node and different from another port allocated to another virtual network.

4. The control apparatus according to claim 1, wherein
the physical resources include a physical link that realizes at least part of a path in a physical network, and
the creation unit creates the virtual network by allocating a physical link that shares at least part of the path and that is different from another physical link allocated to another virtual network.

5. The control apparatus according to claim 1, wherein
a virtual network created by the creation unit has an identifier for identifying the virtual network, and
the resource separation unit separates resources allocated to the virtual network corresponding to the identifier.

6. The control apparatus according to claim 1, wherein
the creation unit creates a virtual network topology in which a first physical network and a second physical network in a layer higher than the first physical network are integrated on the basis of the topologies of the first and the second networks, and
the resource separation unit separates the topology of a virtual network having a specified identifier from the virtual network topology.

7. The control apparatus according to claim 1, wherein
the creation unit creates a virtual network realized over a plurality of physical networks in layers different from each other on the basis of information regarding the topology of the plurality of physical networks.

8. The control apparatus according to claim 6 further comprising a flow operation reception unit configured to receive a flow operation from a user on the basis of the content displayed by the resource separation unit, wherein
the creation unit identifies endpoints of the first and the second physical networks corresponding to the flow operation received by the flow operation reception unit and controls the first and the second physical networks.

9. An information processing apparatus comprising:
an acquisition unit configured to acquire information of one or more virtual networks created on the basis of the state of physical resources; and
a resource separation unit configured to separate resources allocated to the virtual networks for each virtual network.

10. The information processing apparatus according to claim 9, wherein
the acquisition unit acquires information of physical resources allocated to a virtual network to be displayed out of the virtual networks.

11. The information processing apparatus according to claim 9, wherein
the physical resources include a port of a physical node, and
the acquisition unit acquires information of a port allocated to a virtual network to be displayed out of the virtual networks.

12. The information processing apparatus according to claim 9, wherein
the physical resources include a physical link that realizes at least part of a path in a physical network, and
the acquisition unit acquires information of a physical link allocated to a virtual network to be displayed out of the virtual networks.

13. The information processing apparatus according to claim 9, wherein
each of the virtual networks has an identifier for identifying the virtual network, and
the resource separation unit separates resources allocated to the virtual network corresponding to the identifier.

14. The information processing apparatus according to claim 9, wherein
the acquisition unit acquires information of a virtual network created on the basis of information regarding the topologies of a plurality of physical networks in layers different from each other and realized over the plurality of physical networks.

15. The information processing apparatus according to claim 9, wherein
the creation unit of the first control apparatus creates a virtual network topology in which a first physical network and a second physical network in a layer higher than the first physical network are integrated on the basis of the topologies of the first and the second networks, and
the resource separation unit separates the topology of a virtual network having a specified identifier from the virtual network topology.

16. The information processing apparatus according to claim 9 further comprising a flow operation reception unit configured to receive a flow operation from a user on the basis of the content displayed by the resource separation unit, the information processing apparatus notifying the first control apparatus of a flow operation received by the flow operation reception means; and having the first control apparatus identify endpoints of the first and the second physical networks corresponding to the flow operation and control the first and the second physical networks.

17. A method for presenting virtual network, comprising:
acquiring information of a plurality of virtual networks from a first apparatus that comprises creation unit for creating the plurality of virtual networks on the basis of the state of physical resources; and
separating resources allocated to the created virtual networks for each virtual network.

18. A non-transitory computer-readable recording medium storing thereon a program having a computer execute:
a process of acquiring information of a plurality of virtual networks from a first apparatus that comprises creation unit for creating the plurality of virtual networks on the basis of the state of physical resources; and
a process of separating resources allocated to the created virtual networks for each virtual network.

19. The control apparatus according to claim 2, wherein
the physical resources include a port of a physical node, and
the creation unit creates the virtual network by allocating a port realized using the physical node and different from another port allocated to another virtual network.

20. The control apparatus according to claim 2, wherein
the physical resources include a physical link that realizes at least part of a path in a physical network, and
the creation unit creates the virtual network by allocating a physical link that shares at least part of the path and that is different from another physical link allocated to another virtual network.
